(19) United States
(12) Patent Application Publication
(10) Pub. No.: US 2023/0289594 A1
(43) Pub. Date: Sep. 14, 2023

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventor: Yuichi KAMATA, Isehara (JP)

(73) Assignee: Fujitsu Limited, Kawasaki-shi (JP)

(21) Appl. No.: 18/065,944

(22) Filed: Dec. 14, 2022

(30) Foreign Application Priority Data
Mar. 8, 2022 (JP) 2022-035067

(51) Int. Cl. G06N 3/08; G06F 18/2413

(52) U.S. Cl. CPC G06N 3/08; G06F 18/24137

(57) ABSTRACT

A non-transitory computer-readable recording medium storing an information processing program for causing a processor to execute processing including: classifying input data into one or more groups based on a weight of output of each neural network module in a case where data input in training by machine learning is performed for a plurality of neural network modules; and generating, in machine learning processing after the classification, a mini-batch of the input data such that pieces of the input data included in the same group are included in the same mini-batch.

### CROSS-REFERENCE TO RELATED APPLICATION

This application is based upon and claims the benefit of priority of the prior Japanese Patent Application No. 2022-35067, filed on Mar. 8, 2022, the entire contents of which are incorporated herein by reference.

### FIELD

The embodiment discussed herein is related to a machine learning technology including a non-transitory computer-readable storage medium storing an information processing program, an information processing method, and an information processing apparatus .

### BACKGROUND

In recent years, there has been known a method of constructing a neural network by combining a plurality of neural network modules (module group) having basic functions according to content of a task. The neural network module may be called an NN module. The NN is an abbreviation for Neural Network. Furthermore, the neural network constructed by combining the plurality of NN modules may be called a modular neural network.

For example, it has been known to prepare a plurality of types of NN modules that learns assumed functions such as find, and, and compare, and determine a combination of module processing needed to answer a sentence request. At this time, it has also been known to automatically generate, by machine learning, a weight that controls the combination of module processing.

Furthermore, there has also been known a method of selecting and using a parallelized common convolutional neural network (CNN) module to solve a visual question answering (VQA) task. In this method, an NN module selection method is also learned at the same time as CNN processing. Note that, for example, Gumbel-Softmax is also used for weight calculation for module selection.

Examples of the related art include: Japanese Laid-open Patent Publication No. 2020-60838; Japanese Laid-open Patent Publication No. 2020-190895; Ronghang Hu, Jacob Andreas, Trevor Darrell, and Kate Saenko “Explainable Neural Computation via Stack Neural Module Networks” ECCV 2018; and Yanze Wu, Qiang Sun, Jianqi Ma, Bin Li, Yanwei Fu, Yao Peng, Xiangyang Xue “Question Guided Modular Routing Networks for Visual Question Answering” arXiv:1904.08324 are disclosed as related art.

### SUMMARY

According to an aspect of the embodiments, there is provided a non-transitory computer-readable recording medium storing an information processing program for causing a processor to execute processing including: classifying input data into one or more groups based on a weight of output of each neural network module in a case where data input in training by machine learning is performed for a plurality of neural network modules; and generating, in machine learning processing after the classification, a mini-batch of the input data such that pieces of the input data included in the same group are included in the same mini-batch.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing apparatus as an example of an embodiment;

FIG. 2 is a diagram illustrating a hardware configuration of the information processing apparatus as an example of the embodiment;

FIG. 3 is a diagram exemplifying a network structure of a modular neural network;

FIG. 4 is a diagram for describing a neural network (NN) module of the information processing apparatus as an example of the embodiment;

FIG. 5 is a diagram for describing a method of determining a belonging cluster of training data in the information processing apparatus as an example of the embodiment;

FIG. 6 is a diagram illustrating a relationship between a selected NN module and a belonging cluster in the information processing apparatus as an example of the embodiment;

FIG. 7 is a flowchart for describing an outline of processing in the information processing apparatus as an example of the embodiment;

FIG. 8 is a flowchart for describing processing in a probabilistic training phase in the information processing apparatus as an example of the embodiment;

FIG. 9 is a flowchart for describing processing in a deterministic training phase in the information processing apparatus as an example of the embodiment; and

FIG. 10 is a diagram exemplifying the modular neural network trained by the information processing apparatus as an example of the embodiment.

### DESCRIPTION OF EMBODIMENTS

However, in such an existing method of constructing a modular neural network, data for machine learning is input to all NN modules each time and calculation processing is performed, so that output is weighted. At an end of machine learning, only a specific NN module is heavily weighted, so calculation processing on an unrelated NN module (with zero weight) is wasted.

Furthermore, in the case of trying to perform the calculation processing by limiting input of the data for machine learning to only a specific NN module, an NN module to be selected is different for each piece of the input data. Therefore, it is not possible to apply mini-batch processing (perform batch processing of a plurality of pieces of data collectively), which is often used in normal machine learning to improve learning efficiency.

In one aspect, an embodiment aims to enable machine learning to be performed efficiently.

Hereinafter, an embodiment of the present information processing program, information processing method, and information processing apparatus will be described with reference to the drawings. Note that the embodiment to be described below is merely an example, and there is no intention to exclude application of various modifications and technologies not explicitly described in the embodiment. For example, the present embodiment may be variously modified and performed without departing from the spirit thereof. Furthermore, each drawing is not intended to include only components illustrated in the drawings, and may include another function and the like.

### (A) Configuration

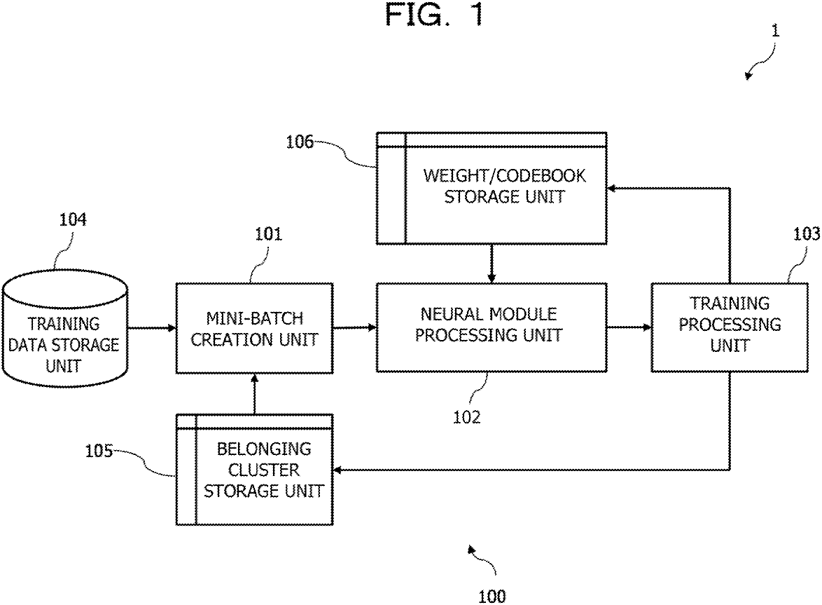

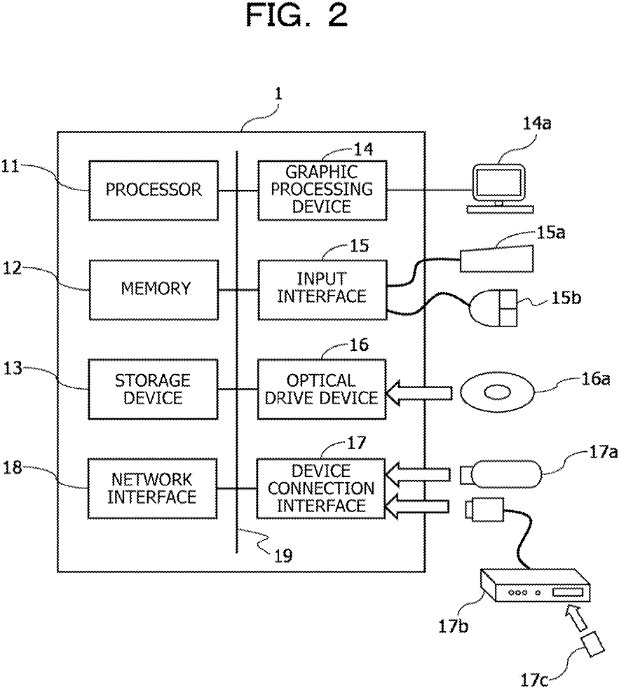

FIG. 1 is a diagram schematically illustrating a configuration of an information processing apparatus 1 as an example of the embodiment, and FIG. 2 is a diagram exemplifying a hardware configuration thereof.

The information processing apparatus 1 is a machine learning device and has a function as a modular neural network training unit 100 that performs training (machine learning) of a modular neural network.

As illustrated in FIG. 1, the modular neural network training unit 100 has functions as a mini-batch creation unit 101, a neural module processing unit 102, a training processing unit 103, a training data storage unit 104, a belonging cluster storage unit 105, and a weight/codebook storage unit 106.

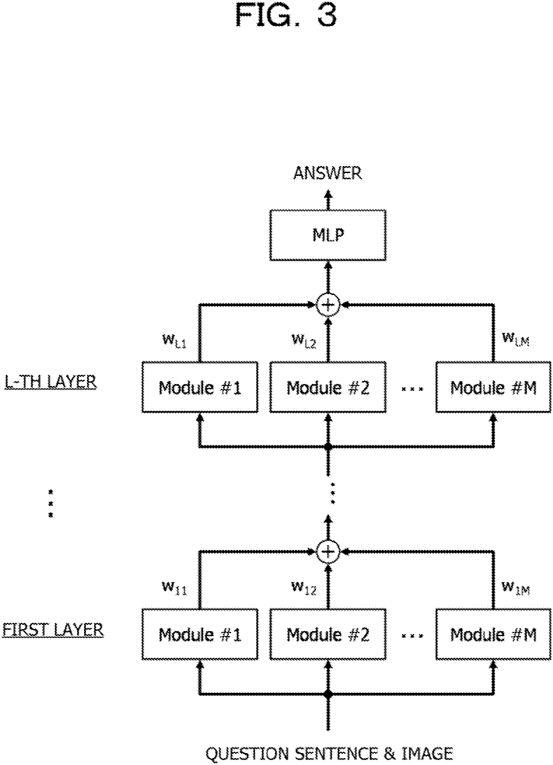

FIG. 3 is a diagram exemplifying a network structure of the modular neural network.

The modular neural network exemplified in FIG. 3 includes L layers, and each of the layers includes M neural network (NN) modules (Modules #1 to #M).

Weights of the respective NN modules (Modules #1 to #M) in a first layer is represented by W_{L1} to W_{1M} • Furthermore, weights of the respective NN modules (Modules #1 to #M) in an L-th layer is represented by W_{L1}to W_{LM} • Hereinafter, in a case where the weight of each NN module is not particularly distinguished, the weight is referred to as weight w.

In the present information processing apparatus 1, the weight w of each NN module is updated by the modular neural network training unit 100 performing training (machine learning) of the modular neural network.

In each layer, even when the weights are widely distributed among the plurality of NN modules (Modules #1 to #M) in an early stage of the training, the weights are concentrated on any one of the plurality of NN modules (Modules #1 to #M) in a final stage of the training. For example, functions acquired by the respective NN modules are clarified.

In the following, an example of applying the modular neural network to a visual question answering (VQA) task is indicated. Training data used for the training of the modular neural network may include question sentences, images, and correct answer data.

A question sentence and an image are input to each NN module in the first layer of the modular neural network.

Each NN module may be a known neural network module, for example, a Transformer block.

As illustrated in FIG. 2, the information processing apparatus 1 includes, for example, a processor 11, a memory 12, a storage device 13, a graphic processing device 14, an input interface 15, an optical drive device 16, a device connection interface 17, and a network interface 18, as components. These components 11 to 18 are configured to be communicable with each other via a bus 19.

The processor (control unit) 11 controls the entire information processing apparatus 1. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), a field programmable gate array (FPGA), and a graphics processing unit (GPU). Furthermore, the processor 11 may be a combination of two or more types of elements of the CPU, MPU, DSP, ASIC, PLD, FPGA, and GPU.

Then, the processor 11 executes a control program (information processing program, OS program) for the information processing apparatus 1, thereby functioning as the modular neural network training unit 100 exemplified in FIG. 1. The OS is an abbreviation for an operating system.

The information processing apparatus 1 implements the function as the modular neural network training unit 100 by, for example, executing a program (information processing program, OS program) recorded in a non-transitory computer-readable recording medium.

A program in which processing content to be executed by the information processing apparatus 1 is described may be recorded in various recording media. For example, the program to be executed by the information processing apparatus 1 may be stored in the storage device 13. The processor 11 loads at least a part of the program in the storage device 13 on the memory 12, and executes the loaded program.

Furthermore, the program to be executed by the information processing apparatus 1 (processor 11) may be recorded in a non-transitory portable recording medium such as an optical disc 16a, a memory device 17a, or a memory card 17c. The program stored in the portable recording medium may be executed after being installed in the storage device 13 under the control of the processor 11, for example. Furthermore, the processor 11 may directly read the program from the portable recording medium and execute the program.

The memory 12 is a storage memory including a read only memory (ROM) and a random access memory (RAM) . The RAM of the memory 12 is used as a main storage device of the information processing apparatus 1. The RAM temporarily stores at least a part of the program to be executed by the processor 11. Furthermore, the memory 12 stores various types of data needed for processing by the processor 11. Moreover, the memory 12 may implement the functions as the weight/codebook storage unit 106 and the belonging cluster storage unit 105.

The storage device 13 is a storage device such as a hard disk drive (HDD), a solid state drive (SSD), or a storage class memory (SCM), and stores various types of data. The storage device 13 is used as an auxiliary storage device of the information processing apparatus 1 .The storage device 13 stores the OS program, the control program, and various types of data. The control program includes the information processing program. Furthermore, the storage device 13 implements the function as the training data storage unit 104.

Note that a semiconductor storage device such as an SCM or a flash memory may be used as the auxiliary storage device. Furthermore, redundant arrays of inexpensive disks (RAID) may be configured by using a plurality of the storage devices 13.

Furthermore, the storage device 13 may store various types of data generated when the mini-batch creation unit 101, the neural module processing unit 102, and the training processing unit 103 described above execute each processing. The storage device 13 may implement the functions as the weight/codebook storage unit 106 and the belonging cluster storage unit 105.

The graphic processing device 14 is connected to a monitor 14a. The graphic processing device 14 displays an image on a screen of the monitor 14a in accordance with an instruction from the processor 11. Examples of the monitor 14a include a display device using a cathode ray tube (CRT), a liquid crystal display device, and the like.

The input interface 15 is connected to a keyboard 15a and a mouse 15b. The input interface 15 transmits signals sent from the keyboard 15a and the mouse 15b to the processor 11. Note that the mouse 15b is an example of a pointing device, and another pointing device may be used. Examples of the another pointing device include a touch panel, a tablet, a touch pad, a track ball, and the like.

The optical drive device 16 reads data recorded in the optical disc 16a by using laser light or the like. The optical disc 16a is a non-transitory portable recording medium having data recorded in a readable manner by reflection of light. Examples of the optical disc 16a include a digital versatile disc (DVD), a DVD-RAM, a compact disc read only memory (CD-ROM), a CD-recordable (R) /rewritable (RW), and the like.

The device connection interface 17 is a communication interface for connecting a peripheral device to the information processing apparatus 1. For example, the device connection interface 17 may be connected to the memory device 17a and a memory reader/writer 17b. The memory device 17a is a non-transitory recording medium equipped with a communication function with the device connection interface 17, for example, a universal serial bus (USB) memory. The memory reader/writer 17b writes data to the memory card 17c or reads data from the memory card 17c. The memory card 17c is a card-type non-transitory recording medium.

The network interface 18 is connected to a network. The network interface 18 transmits and receives data via the network. Another information processing apparatus, communication device, or the like may be connected to the network. For example, the function as the training data storage unit 104 may be provided in another information processing apparatus or storage device connected via the network.

The present information processing apparatus 1 constructs the modular neural network by combining the plurality of NN modules.

The modular neural network training unit 100 performs the training of the modular neural network in two phases: a probabilistic training phase and a deterministic training phase. The probabilistic training phase may be called a first half of the training, and further, the deterministic training phase may be called a second half of the training. In the deterministic training phase, the training is performed by selecting only one NN module from the plurality of (M) NN modules in the same layer.

The mini-batch creation unit 101 creates a mini-batch used for training of each NN module included in the modular neural network.

The mini-batch creation unit 101 creates, in the probabilistic training phase, a mini-batch (first mini-batch) by extracting a predetermined number of pieces of training data from a plurality of pieces of training data stored in the training data storage unit 104. The mini-batch creation unit 101 may create the first mini-batch by, for example, randomly extracting the predetermined number of pieces of training data from the plurality of pieces of training data. The created first mini-batch may be stored in the training data storage unit 104.

Furthermore, the mini-batch creation unit 101 creates, in the deterministic training phase, a mini-batch (second mini-batch) by extracting a predetermined number of pieces (the number of mini-batches) of training data from a plurality of pieces of training data having the same belonging cluster set by the training processing unit 103 to be described later. The belonging cluster is a group. The belonging cluster may be called a class. The mini-batch creation unit 101 may create the second mini-batch by, for example, randomly extracting the predetermined number of pieces of training data from the plurality of pieces of training data having the same belonging cluster.

In this way, the mini-batch creation unit 101 generate the mini-batch (second mini-batch) of the training data such that pieces of the training data included in the same group are included in the same mini-batch. The created second mini-batch may be stored in the training data storage unit 104.

The neural module processing unit 102 performs processing on the plurality of NN modules included in the modular neural network in each of the probabilistic training phase and the deterministic training phase.

It is assumed that the number of NN modules (number of modules) included in each layer of the modular neural network is M. The symbol M denotes a natural number.

In the probabilistic training phase, the neural module processing unit 102 inputs training data to all the M NN modules and obtains output from each.

In the NN module, the neural module processing unit 102 causes a weight distribution for the output of the NN module to be calculated by multilayer perceptron (MLP) processing based on a head token ([BOS] token) of input question sentence data.

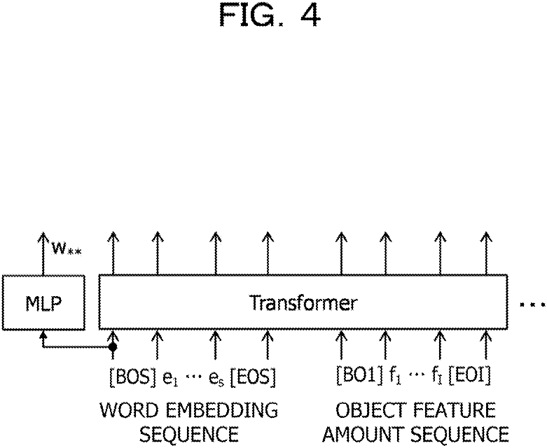

FIG. 4 is a diagram for describing the NN module of the information processing apparatus 1 as an example of the embodiment.

FIG. 4 indicates an example in which the NN module is the Transformer block. A word embedding sequence of a question sentence and an object feature amount sequence of image data are input to the Transformer block. [BOS] of the word embedding sequence is also input to an MLP and used to calculate the weight w.

The neural module processing unit 102 uses weighted average output in the M NN modules of each layer as input to the succeeding layer (next layer), and causes the weight distribution for the output of the NN modules to be calculated. The neural module processing unit 102 causes each layer of the modular neural network to calculate each weight distribution.

The neural module processing unit 102 performs MLP processing on output of each NN module in a final layer of the modular neural network, and obtains answer output as class classification from options.

In the probabilistic training phase, the processing described above by the neural module processing unit 102 is repeatedly executed a specified number of times (for example, N_{f} epoch in learning data amount).

Furthermore, in the deterministic training phase, the neural module processing unit 102 performs processing on each NN module by using training data of the second mini-batch created by the mini-batch creation unit 101.

The neural module processing unit 102 selects only one piece of the training data from within the second mini-batch.

Then, the neural module processing unit 102 causes the NN module to calculate the weight distribution for the output of the M NN modules that configure the first layer from a head token of the selected training data by the MLP processing, and selects an NN module with the maximum weight. With this configuration, the NN module to be selected in the first layer is determined. Among the M NN modules provided in one layer of the modular neural network, the NN module selected with the maximum weight may be called a selected NN module.

The neural module processing unit 102 gives training data of all mini-batches only to the selected NN module to cause the selected NN module to calculate output. The neural module processing unit 102 uses the output of the selected NN module of each layer as input to the next layer.

In the deterministic training phase, the neural module processing unit 102 performs, for all the layers up to the L-th layer, the data input to the M NN modules, the calculation of the weight distribution to the output of the M NN modules by the MLP processing, the selection of the NN module with the maximum weight, and the like described above.

In this way, in the deterministic training phase (second half of the training), the neural module processing unit 102 collectively performs calculation processing in a mini-batch including pieces of training data extracted from the same cluster.

In the deterministic training phase (second half of the training), by determining that the pieces of training data in the same cluster have the same NN module to be selected, mini-batch processing is implemented in which the calculation processing is limited only to a specific NN module by using data of the same cluster.

Then, the neural module processing unit 102 performs the MLP processing on the output of the final layer of the modular neural network, and obtains class classification from answer options.

The training processing unit 103 creates, in the probabilistic training phase, K feature amount codebooks {c₁, ..., C_{K}} with random values. The symbol K denotes the number of clusters. Each feature amount codebook corresponds to any one of clusters (groups).

Furthermore, in the probabilistic training phase, the training processing unit 103 uses a vector in which the weights for the output of the NN modules of all the layers (L layers) are arranged in a sequence as a feature amount, to determine, based on the feature amount, a belonging cluster of each piece of training data from a distance from the feature amount codebook. The determination of the belonging cluster of the training data corresponds to classification of input data (training data) into groups.

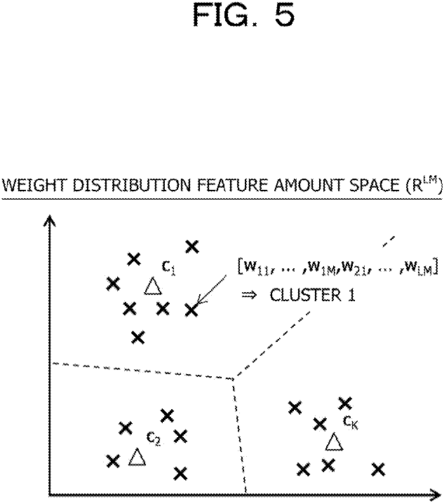

FIG. 5 is a diagram for describing a method of determining the belonging cluster of the training data in the information processing apparatus 1 as an example of the embodiment.

FIG. 5 indicates a plurality of pieces of training data arranged in a weight distribution feature space (R^{LM}) . In FIG. 5, a plurality of crosses (×) each represent a weight distribution vector of the training data, and a plurality of Δ each represent a feature amount codebook.

The plurality of pieces of training data is clustered according to a distance from the feature amount codebooks {c₁, ..., C_{K}} .

For example, the training processing unit 103 may select a feature amount codebook nearest (nearest neighbor) to the weight distribution vector of the training data from among the feature amount codebooks {c₁, ..., C_{K}}, and determine a cluster to which the selected feature amount codebook corresponds as a belonging cluster of the training data.

The feature amount codebook corresponds to reference information representing a cluster.

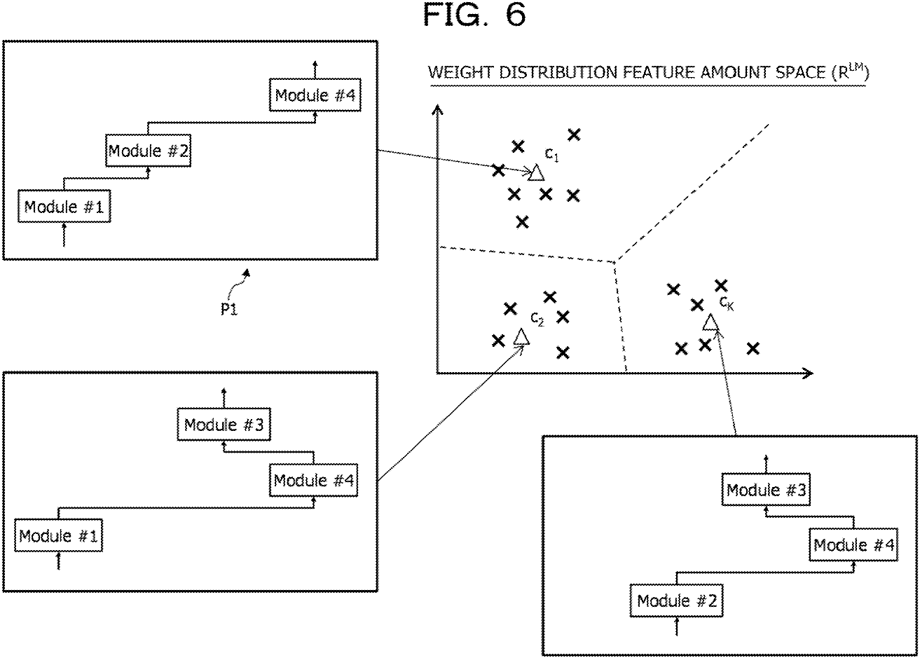

FIG. 6 is a diagram illustrating a relationship between the selected NN module and the belonging cluster in the information processing apparatus 1 as an example of the embodiment.

FIG. 6 indicates combinations of the NN modules and belonging clusters of output in association with each other. Each of the Modules #1 to #4 in FIG. 6 represents the NN module, and the Modules #1 to #4 indicate three layers that are partially arranged one behind another in the modular neural network.

In the modular neural network, a belonging cluster of output of the modular neural network is determined according to a combination of NN modules that process training data.

For example, in the modular neural network, in a case where the training data is processed by the Module #1, then by the Module #2, and then by the Module #4, the output of the modular neural network is a cluster C₁ (refer to a symbol P1) .

In the probabilistic training phase (first half of the training), the training processing unit 103 clusters the training data by using a weight distribution as a feature amount. The training processing unit 103 classifies input data into one or more clusters (groups) based on a weight of output of each NN module.

The training processing unit 103 inputs the training data (input data) to the modular neural network, and determines a belonging cluster (group) of the training data based on a distance between a vector (feature amount) generated based on the weight for the output of the plurality of NN modules and the feature amount codebook (reference information).

The training processing unit 103 causes the belonging cluster storage unit 105 to store the determined belonging cluster of each piece of the training data.

The belonging cluster storage unit 105 associates and stores the belonging cluster determined by the training processing unit 103 for each of the plurality of pieces of training data. The belonging cluster storage unit 105 stores cluster information regarding the training data. By referring to the belonging cluster storage unit 105, training data belonging to a specific cluster may be obtained.

The training processing unit 103 updates a value of the feature amount codebook in a nearest neighbor feature amount direction by competitive learning.

When it is assumed that a feature amount codebook which is the nearest neighbor to a feature amount w⁽ⁿ⁾ of a weight distribution in data n in a mini-batch is c⁽ⁿ⁾, update of the feature amount codebook c⁽ⁿ⁾ by the competitive learning is represented by the following Expression (1).

$${\text{c}}^{\left(\text{n}\right)} ← \left(1 - \text{β}\right) {\text{c}}^{\left(\text{n}\right)} + \text{β} {\text{w}}^{\left(\text{n}\right)} \qquad \text{(1)}$$

, where β is an adjustment coefficient for training and may be set optionally.

The training processing unit 103 performs machine learning of the NN modules by supervised learning by an error back propagation method, and updates the weights of the respective NN modules.

In the probabilistic training phase, the training processing unit 103 uses “a class classification error in VQA” + “a distance error from a feature amount codebook” as a learning loss.

In the probabilistic training phase, the training processing unit 103 performs training of the NN modules by supervised machine learning by the error back propagation method using the sum of the class classification error (classification error of a group) in VQA and the distance error from the feature amount codebook (reference information) as the learning loss.

When it is assumed that probability output of a network in a correct answer class of the data n in the mini-batch is p⁽ⁿ⁾, the class classification error in VQA is represented by the following expression (2).

$$- {\sum }_{n} log \left({p}^{\left(n\right)}\right) \qquad \text{(2)}$$

Furthermore, the distance error from the feature amount codebook is represented by the following expression (3).

$$γ {{\sum }_{n} \left‖{w}^{\left(n\right)} - {c}^{\left(n\right)}\right‖}_{2}$$

(3)

In the expression (3) described above, w⁽ⁿ⁾ is the feature amount of the weight distribution on the data n in the mini-batch, and c⁽ⁿ⁾ is the nearest neighbor feature amount codebook. Furthermore, γ is an adjustment coefficient for learning, and may be set optionally.

In the probabilistic training phase, the processing described above by the training processing unit 103 is repeatedly executed a specified number of times (for example, N_{f} epoch in training data amount).

Each value of the feature amount codebook and the weight value set by the training processing unit 103 are stored in the weight/codebook storage unit 106.

Furthermore, in the deterministic training phase, the training processing unit 103 updates the weights of the respective NN modules by supervised learning based on the class classification (output data) from the answer options obtained from the modular neural network.

### (B) Operation

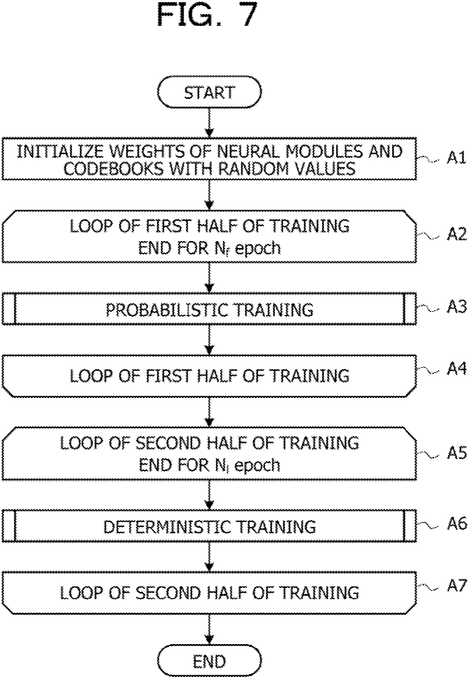

An outline of processing in the information processing apparatus 1 as an example of the embodiment configured as described above will be described with reference to a flowchart (Steps A1 to A7) illustrated in FIG. 7.

In Step A1, for example, the training processing unit 103 initializes weights of the respective NN modules and feature amount codebooks with random values.

In Step A2, loop processing is started in which processing in Step A3 is repeatedly performed until the number of times of training reaches a specified number of times (N_{f} epoch) .

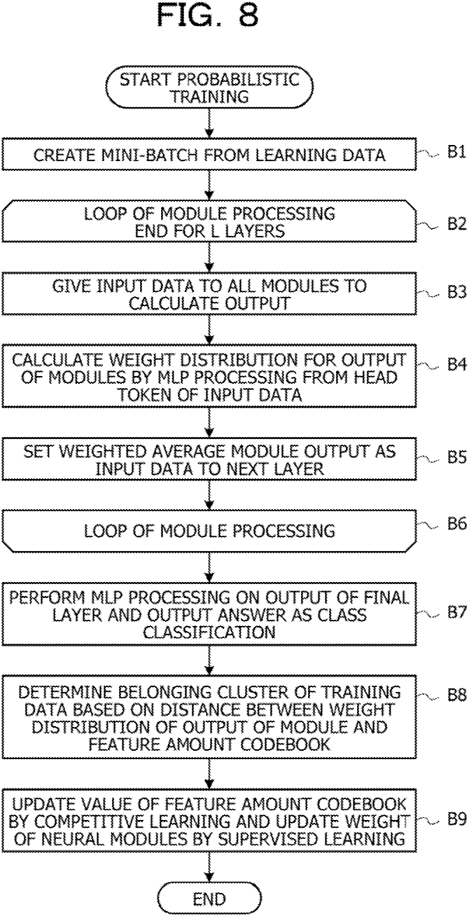

In Step A3, the probabilistic training is executed. Details of the probabilistic training will be described later with reference to FIG. 8.

In Step A4, loop end processing corresponding to Step A2 is performed. Here, when the number of times of training reaches the specified number of times (N_{f} epoch), the control proceeds to Step A5 .

In Step A5, loop processing is started in which processing in Step A6 is repeatedly performed until the number of times of training reaches a specified number of times (N₁ epoch) .

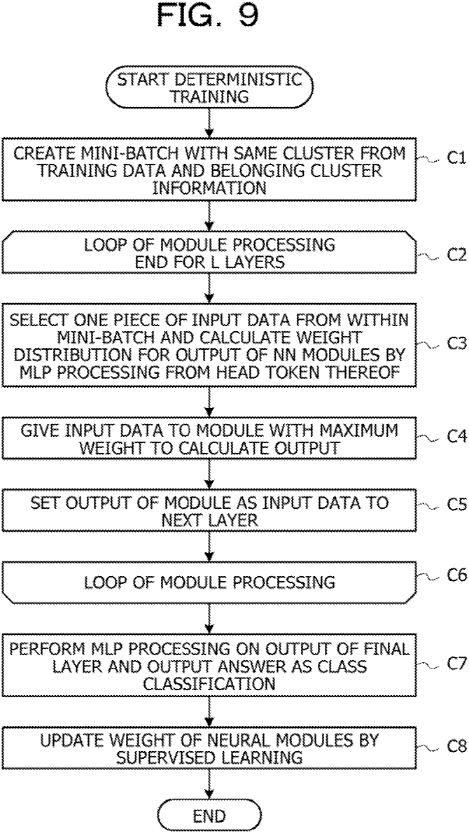

In Step A6, the deterministic training is executed. Details of the deterministic training will be described later with reference to FIG. 9.

In Step A7, loop end processing corresponding to Step A5 is performed. Here, when the number of times of training reaches the specified number of times (N₁ epoch), the processing ends.

Next, processing in the probabilistic training phase in the information processing apparatus 1 as an example of the embodiment will be described with reference to a flowchart (Steps B1 to B9) illustrated in FIG. 8.

In Step B1, the mini-batch creation unit 101 creates a mini-batch (first mini-batch) by extracting a predetermined number of pieces of training data from a plurality of pieces of training data.

In Step B2, loop processing is started in which control up to Step B6 is repeatedly performed for all the layers (L layers) of the modular neural network. The processing of Steps B2 to B6 is processed in order (ascending order) from the first layer (input layer) to the L-th layer (output layer) for the plurality of layers included in the modular neural network.

In Step B3, the neural module processing unit 102 gives the training data (input data) to all M NN modules configuring a layer to be processed, and causes each NN module to calculate output.

In Step B4, the neural module processing unit 102 causes a weight distribution for the output of the NN modules to be calculated by the MLP processing from a head token of selected training data.

In Step B5, the neural module processing unit 102 sets weighted average module output of the respective NN modules as input data to the next layer.

In Step B6, loop end processing corresponding to Step B2 is performed. Here, when the processing for all the layers (L layers) is completed, the control proceeds to Step B7.

In Step B7, the neural module processing unit 102 performs the MLP processing on the output of the final layer of the modular neural network, and obtains class classification from answer options.

In Step B8, the training processing unit 103 determines a belonging cluster of each piece of the training data based on a distance between the weight distribution of the output of each NN module and the feature amount codebook.

In Step B9, the training processing unit 103 updates a value of the feature amount codebook in a nearest neighbor feature amount direction by competitive learning. Furthermore, the training processing unit 103 performs machine learning of the NN modules by supervised learning, and updates the weights of the respective NN modules. Thereafter, the processing ends.

Next, processing in the deterministic training phase in the information processing apparatus 1 as an example of the embodiment will be described with reference to a flowchart (Steps C1 to C8) illustrated in FIG. 9.

In Step C1, the mini-batch creation unit 101 creates a mini-batch (second mini-batch) by extracting a predetermined number of pieces (the number of mini-batches) of training data from a plurality of pieces of training data having the same belonging cluster set by the training processing unit 103.

In Step C2, loop processing is started in which control up to Step C6 is repeatedly performed for all the layers (L layers) of the modular neural network. The processing of Steps C2 to C6 is processed in order (ascending order) from the first layer (input layer) to the L-th layer (output layer) for the plurality of layers included in the modular neural network.

In Step C3, the neural module processing unit 102 selects one piece of the training data from within the second mini-batch created by the mini-batch creation unit 101. The neural module processing unit 102 causes the NN module to calculate a weight distribution for the output of the M NN modules that configure the first layer from a head token of the selected training data by the MLP processing.

In Step C4, the neural module processing unit 102 selects an NN module with the maximum weight (selected NN module), gives training data of all the mini-batches to the selected NN module, and causes the selected NN module to calculate output.

In Step C5, the neural module processing unit 102 sets the output of the selected NN module as input to the next layer.

In Step C6, loop end processing corresponding to Step C2 is performed. Here, when the processing for all the layers (L layers) is completed, the control proceeds to Step C7.

In Step C7, the neural module processing unit 102 performs the MLP processing on the output of the final layer of the modular neural network, and obtains a class classification answer.

In Step C8, the training processing unit 103 updates the weights of the respective NN modules by supervised learning based on the class classification (output data) from the answer options obtained from the modular neural network. Thereafter, the processing ends.

### (C) Effects

In this way, according to the information processing apparatus 1 as an example of the embodiment, in the probabilistic training phase, a plurality of pieces of training data is clustered by using a weight distribution as a feature amount. Then, in the deterministic training phase, the mini-batch creation unit 101 generate a mini-batch (second mini-batch) of the training data such that pieces of the training data included in the same cluster (group) are included in the same mini-batch.

In the deterministic training phase, cluster information regarding the training data is used to determine that the pieces of training data in the same cluster have the same NN module to be selected. With this configuration, it is possible to implement mini-batch processing in which calculation processing is limited only to a specific NN module by using the training data within the same cluster. Furthermore, it is possible to improve training efficiency of the modular neural network.

In the probabilistic training phase, the training processing unit 103 performs machine learning of the NN modules by supervised learning by the error back propagation method by using “a class classification error in VQA” + “a distance error from a feature amount codebook” as a learning loss, and updates weights of the respective NN modules.

With this configuration, in the modular neural network, the class classification error in VQA and the distance error from the feature amount codebook are reflected in the NN module of each layer that is finally selected by training. Then, it becomes possible to perform mini-batch processing using a mini-batch including only the training data belonging to the same cluster.

In the deterministic training phase, the neural module processing unit 102 selects an NN module with the maximum weight (selected NN module) in each layer, gives training data of all the mini-batches to the selected NN module, and causes the selected NN module to calculate output.

By performing training of the selected NN module with a mini-batch including only training data belonging to a cluster that has a large influence on the NN module, it is possible to perform training of each NN module efficiently.

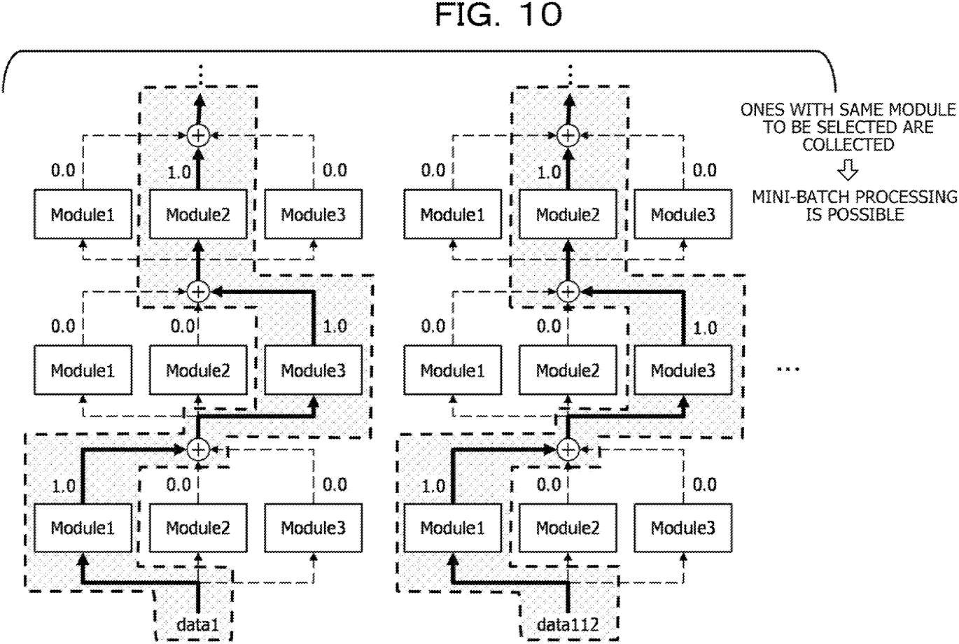

FIG. 10 is a diagram exemplifying the modular neural network trained by the information processing apparatus 1 as an example of the embodiment.

FIG. 10 indicates an example in which each of data1 and data 112 is input to the modular neural network. Since these data 1 and data 112 belong to the same cluster, an NN module to be selected in each layer is also the same.

In the present information processing apparatus 1 (modular neural network training unit 100), mini-batch processing becomes possible by creating a second mini-batch in which a plurality of pieces of training data for selecting the same NN module in each layer of the modular neural network is collected. Therefore, it is possible to efficiently perform training of the modular neural network.

### (D) Others

Each configuration and each processing of the present embodiment may be selected or omitted as needed or may be appropriately combined.

Additionally, the disclosed technology is not limited to the embodiment described above, and various modifications may be made and performed without departing from the spirit of the present embodiment.

Furthermore, the present embodiment may be performed and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a processor to execute processing comprising:
classifying input data into one or more groups based on a weight of output of each neural network module in a case where data input in training by machine learning is performed for a plurality of neural network modules; and
generating, in machine learning processing after the classification, a mini-batch of the input data such that pieces of the input data included in the same group are included in the same mini-batch.

2. The non-transitory computer-readable recording medium according to claim 1, wherein
the plurality of neural network modules is included in a modular neural network.

3. The non-transitory computer-readable recording medium according to claim 2, wherein
the processing of classifying includes
processing of inputting the input data to the modular neural network, and determining a group of the input data based on a distance between a vector generated based on a weight for output of the plurality of neural network modules and reference information that represents a cluster.

4. The non-transitory computer-readable recording medium according to claim 3, for causing the processor to execute the processing further comprising
updating the reference information in a nearest neighbor feature amount direction by competitive learning.

5. The non-transitory computer-readable recording medium according to claim 3, for causing the processor to execute the processing further comprising performing training of the neural network module by supervised machine learning by an error back propagation method that uses a sum of a classification error of the group and a distance error from the reference information as a learning loss.

6. An information processing method implemented by a computer, the method comprising:
classifying input data into one or more groups based on a weight of output of each neural network module in a case where data input in training by machine learning is performed for a plurality of neural network modules; and
generating, in machine learning processing after the classification, a mini-batch of the input data such that pieces of the input data included in the same group are included in the same mini-batch.

7. An information processing apparatus comprising:
a memory; and
a processor being coupled to the memory, the processor being configured to perform processing including:
classifying input data into one or more groups based on a weight of output of each neural network module in a case where data input in training by machine learning is performed for a plurality of neural network modules; and
generating, in machine learning processing after the classification, a mini-batch of the input data such that pieces of the input data included in the same group are included in the same mini-batch.
